(19) United States
(12) Patent Application Publication
(10) Pub. No.: US 2011/0051004 A1
(43) Pub. Date: Mar. 3, 2011

(54) VIDEO SIGNAL PROCESSING APPARATUS AND METHOD AND PROGRAM FOR PROCESSING VIDEO SIGNALS

(75) Inventors: Hironori MORI, Kanagawa (JP); Yosuke YAMAMOTO, Chiba (JP)

(73) Assignee: Sony Corporation, Tokyo (JP)

(21) Appl. No.: 12/853,633

(22) Filed: Aug. 10, 2010

(30) Foreign Application Priority Data
Aug. 26, 2009 (JP) 2009-195007

(51) Int. Cl. H04N 9/76

(52) U.S. Cl. 348/598; 348/E09.057

(57) ABSTRACT

A video signal processing device includes: a first video signal processing section performing a first process on an input video signal for displaying a composite image that is a combination of a natural image and an artificial image, the first process being performed on pixels in a region larger than an artificial image combining region and being a process on which pixels within the combining region have influence; a second video signal processing section performing a second process on the input video signal, the second process being performed on pixels in a region larger than the combining region and being a process on which pixels within the combining region have no influence; and

a process restricting section restricting the first process in a first region overlapping and encompassing the combining region and restricting the second process in a second region which is identical to the artificial image combining region.

### BACKGROUND OF THE INVENTION

1. Field of the Invention

The present invention relates to a video signal processing apparatus and a method and a program for processing video signals. More particularly, the invention relates to a video signal processing apparatus which performs image quality improving processes on video signals for displaying a composite image that is a combination of a natural image and an artificial image such as graphics or characters.

2. Description of the Related Art

It has been known that a television receiver performs image quality improving processes on video signals, including a sharpness improving process, a contrast improving process, and a color improving process. In the case of a video signal for displaying a composite image that is a combination of a natural image and an artificial image such as graphics or characters, the problem of variation of luminance or color has occurred even in the region of the artificial image under the influence of the image quality improving processes.

For example, a solution to the above problem is proposed in JP-A-2007-228167 (Patent Document 1), the solution including the steps of setting a mask area extending the same range as a region having an artificial image (OSD region), outputting a video signal for the mask area without performing any image quality improving process on the signal, and outputting a video signal for the remaining region with image quality improving processes performed thereon. In this case, no variation of luminance or color occurs in the region having an artificial image because the region is not affected by image quality improving processes.

### SUMMARY OF THE INVENTION

For example, when a sharpness improving process is performed as an image quality improving process, the technique disclosed in Patent Document 1 has the following problem. The sharpness improving process can leave noticeable pre-shooting and over-shooting effects as shown in FIG. 14 in a natural image region (in a part of the region adjoining an artificial image) when the entire image to be processed is as shown in FIG. 13. In FIG. 14, the rectangular window shown in a broken line represents a mask area extending the same range as an artificial image region. FIGS. 15A to 15C schematically illustrate the sharpness improving process. The sharpness improving process includes the steps of extracting a high frequency component (FIG. 15B) from an input video signal (FIG. 15A) and adding the extracted high frequency component to the input video signal to obtain an output video signal having a pre-shoot and an over-shoot added thereon (FIG. 15C).

An alternative approach includes the steps of setting a mask area overlapping and encompassing a region having an artificial image therein, outputting a video signal for the mask area with no image quality improving process performed thereon, and outputting a video signal for the remaining region with image quality improving processes performed thereon. For example, when a contrast improving process and a color improving process are performed as image quality improving processes, a problem arises in that a boundary between the processed and unprocessed regions are visually noticeable as shown in FIG. 16. In FIG. 16, the rectangular window shown in a broken line represents the mask area overlapping and encompassing the artificial image region.

Under the circumstance, it is desirable to prevent any reduction in image quality from being caused by a mask area which is set to keep a region including an artificial image therein unaffected by an image quality improving process.

According to an embodiment of the invention, there is provided a video signal processing device including:

a first video signal processing section performing a first process on an input video signal for displaying a composite image that is a combination of a natural image and an artificial image, the first process being performed on pixels in a region larger than an artificial image combining region and being a process on which pixels within the artificial image combining region have influence;

a second video signal processing section performing a second process on the input video signal, the second process being performed on pixels in a region larger than the artificial image combining region and being a process on which pixels within the artificial image combining region have no influence; and

a process restricting section restricting the first process performed by the first video signal processing section in a first region overlapping and encompassing the artificial image combining region and restricting the second process performed by the second video signal processing section in a second region which is identical to the artificial image combining region.

According to the embodiment of the invention, the first video signal processing section performs a first process on an input video signal. The first process may be such a process that pixels within the artificial image combining region have influence on pixels in the region larger than the artificial image combining region. For example, the first process may be a sharpness improving process for extracting a high frequency component from the input video signal and adding the extracted high frequency component to the input video signal.

When a region identical to the artificial image combining region is used as a mask area to restrict the process such that a video signal corresponding to the region is output without being subjected to the sharpness improving process and such that a video signal corresponding the other regions is output with being subjected to the sharpness improving process, a problem arises in that pre-shoot and over-shoot effects attributable to sharpness improvement can be visually noticeable in a region where a natural image is displayed.

Under the circumstance, according to the embodiment of the invention, the process restricting section restricts the first process performed by the first video signal processing section in the first region which overlaps and encompasses the region where the artificial image is combined. For example, when the first process is a sharpness improving process, the problem of visually noticeable pre-shoot and over-shoot effects attributable to sharpness improvement can be eliminated in the natural image region.

According to the embodiment of the invention, the second video signal processing section performs the second process on the input video signal. The second process may be such a process that pixels within the artificial image combining region have no influence on pixels in the region larger than the artificial image combining region. For example, the second process may be a contrast improving process performed on a luminance signal constituting the input video signal or a color improving process performed on a chrominance signal constituting the input video signal.

When a region overlapping and encompassing the artificial image combining region is used as a mask area to restrict the process such that a video signal corresponding to the region is output without being subjected to the contrast improving process or color improving process and such that a video signal corresponding to the other region is output with being subjected to the sharpness improving process or color improving process, a problem arises in that the process is likely to leave a visually noticeable boundary between processed and unprocessed areas.

Under the circumstance, according to the embodiment of the invention, the process restricting section restricts the second process performed by the second video signal processing section in the second region. For example, when the second process is a contrast improving process or color improving process, the problem of a visually noticeable boundary between processed and unprocessed areas can be eliminated in the natural image region.

According to the embodiment of the invention, a mask signal generating section may be provided to generate a first mask signal representing the first region and a second mask signal representing the second region. The process restricting section may restrict the first process performed by the first video signal processing section based on the first mask signal generated by the mask signal generating section and may restrict the second process performed by the second video signal processing section based on the second mask signal generated by the mask signal generating section.

According to the embodiment of the invention, a combining region detecting section may be provided to acquire information on the artificial image combining region based on an input video signal. The process restricting section may restrict the first process performed by the first video signal processing section to the first region overlapping and encompassing the artificial image combining region and may restrict the second process performed by the second video signal processing section to the second region which is identical to the artificial image combining region, based on the information on the artificial image combining region obtained by the combining region detecting section.

According to the embodiment of the invention, a video signal combining section may be provided to obtain an input video signal by combining a first video signal for displaying a natural image with a second video signal for displaying an artificial image. The process restricting section may restrict the first process performed by the first video signal processing section to the first region overlapping and encompassing the artificial image combining region and may restrict the second process performed by the second video signal processing section to the second region which is identical to the artificial image combining region, based on information on the artificial image combining region in the video signal combining section.

According to the embodiment of the invention, the video signal processing section may start relaxing the degree of the restriction on the first process by the first video signal processing section at the outline of the artificial image combining region and may gradually relax the restriction toward the outline of the first region. In this case, since the outline of the first region does not constitute a processing boundary of the first process, the first region can be prevented from becoming visually noticeable as a boundary between processed and unprocessed areas.

According to the embodiment of the invention, processes on a composite image is restricted by providing two regions in which the processes are to be restricted (mask areas), i.e., the first region overlapping and encompassing the artificial image combining region and the second region identical to the artificial image combining region. It is therefore possible to prevent degradation of image quality which can otherwise occur when the mask area is set to prevent an image quality improving process from affecting the artificial image combining region.

### BRIEF DESCRIPTION OF THE DRAWINGS

FIG. 1 is a block diagram showing an exemplary configuration of a television receiver as an embodiment of the invention;

FIG. 2 is a block diagram showing an exemplary configuration of an image quality improving process section forming part of the television receiver;

FIG. 3 is an illustration for explaining an A-region (a region overlapping and encompassing an artificial image combining region) and a B-region (a region identical to the artificial image combining region);

FIG. 4 is a block diagram showing an exemplary configuration of a mask signal generating portion forming part of the image quality improving process section;

FIGS. 5A to 5C show examples of changes that occur in an A-region horizontal control signal h_mask_A and a B-region horizontal control signal h_mask_B relative to the horizontal synchronization signal HD;

FIGS. 6A to 6C show examples of changes that occur in an A-region vertical control signal v_mask_A and a B-region vertical control signal v_mask_B relative to the vertical synchronization signal VD;

FIGS. 7A to 7C are diagrams for explaining a sharpness improving process which is restricted in an A-region overlapping and encompassing an artificial image combining region;

FIG. 8 shows an example of an image displayed using the image quality improving process section with restriction placed on the process in two regions, i.e., A- and B-regions;

FIGS. 9A to 9D show examples of signals associated with the sharpness improving process performed by the image quality improving process section;

FIG. 10 is a block diagram showing another exemplary configuration of the image quality improving process section forming part of the television receiver;

FIGS. 11A to 11D show examples of signals associated with the sharpness improving process performed by the image quality improving process section;

FIG. 12 is a graph showing an example of a change that occurs in a marginal area of a mask signal mask_A;

FIG. 13 is an illustration showing an example of a composite image obtained by combining a natural image with an artificial image;

FIG. 14 is an illustration showing an example of a composite image obtained by combining a natural image and an artificial image, in which pre-shoot and over-shoot effects attributable to sharpness improvement is visually noticeable in the region of the natural image;

FIGS. 15A to 15C are diagrams for explaining the sharpness improving process; and

FIG. 16 is an illustration showing an example of a composite image obtained by combining a natural image and an artificial image, in which a processing boundary attributable to a contrast improving process and a color improving process is visually noticeable in the region of the natural image.

### DESCRIPTION OF PREFERRED EMBODIMENTS

Modes for implementing the invention (hereinafter referred to as embodiment) will now be described in the following order.

1. Embodiment

2. Modification

### 1. Embodiment

### Exemplary Configuration of Television Receiver

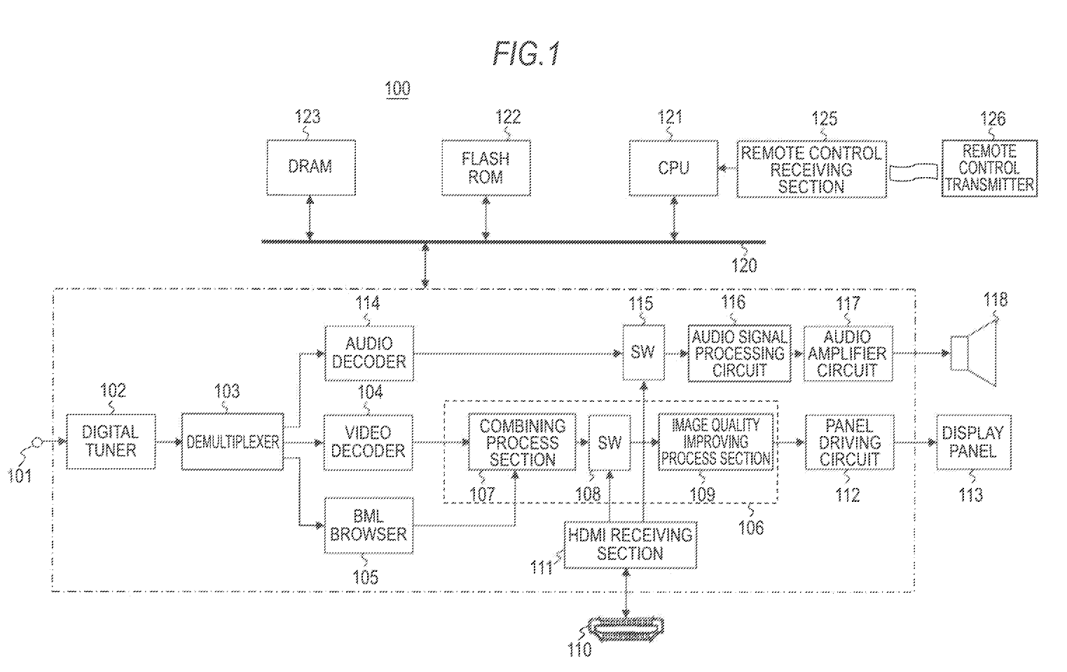

An exemplary configuration of a television receiver 100 as an embodiment of the invention will now be described. FIG. 1 shows the exemplary configuration of the television receiver 100. The television receiver 100 includes an antenna terminal 101, a digital tuner 102, a demultiplexer 103, a video decoder 104, a BML (broadcast markup language) browser 105, and a video signal processing circuit 106. The video signal processing circuit 106 includes a combining process section 107, a switch section 108, and an image quality improving process section 109.

The television receiver 100 also includes an HDMI (High-Definition Multimedia Interface) terminal 110, an HDMI receiving section 111, a panel driving circuit 112, and a display panel 113. The television receiver 100 further includes an audio decoder 114, a switch section 115, an audio signal processing circuit 116, an audio amplifier circuit 117, and a speaker 118.

The television receiver 100 also includes an internal bus 120 and a CPU (central processing unit) 121. The television receiver 100 also includes a flash ROM (read only memory) 122 and a DRAM (dynamic random access memory) 123. The television receiver 100 further includes a remote control receiving section 125, and a remote control transmitter 118.

The antenna terminal 101 is a terminal to which television broadcast signals received by a receiving antenna are input. The digital tuner 102 processes television broadcast signals input to the antenna terminal 101 to output a predetermined stream (bit stream data) associated with a channel selected by a user.

The demultiplexer 103 extracts a video stream, an audio stream, and a data stream from a transport stream (TS). The demultiplexer 103 extracts required streams based on the value of a PID (packet identification) stored in a header portion of each TS packet included in the transport stream. The video decoder 104 performs a decoding process on a video stream extracted by the demultiplexer 103 to obtain a baseband (uncompressed) image data (video signals). Such image data are image data for displaying a natural image.

The BML browser 105 obtains BML data from a data stream extracted by the demultiplexer 103, analyzes the structure of the data, and generates image data (video signals) for a data broadcast. Such image data are image data for displaying an artificial image such as graphics or characters. The combining process section 107 combines image data obtained by the video decoder 104 with image data for a data broadcast generated by the BML browser 105 according to an operation performed by a user.

The HDMI terminal 110 is a terminal for connecting an HDMI source apparatus to the television receiver 100 serving as an HDMI sink apparatus. For example, the HDMI source apparatus may be a DVD (digital versatile disc) recorder, a BD (Blu-ray disc) recorder, or a set top box. The HDMI source apparatus is connected to the HDMI terminal 110 through an HDMI cable which is not shown.

The HDMI receiving section 111 performs communication according to the HDMI standard to receive baseband (uncompressed) image and audio data supplied from the HDMI source apparatus to the HDMI terminal 110 through the HDMI cable. Such image data received by the HDMI receiving section 111 are image data for displaying a natural image or image data for displaying a composite image that is a combination of a natural image and an artificial image. For example, such an artificial image may be an image of a menu displayed on the HDMI source apparatus.

The switch section 108 selectively acquires image data output by the combining process section 107 or image data received at the HDMI receiving section 111 according to an operation performed by a user. Image data output by the combining process section 107 are acquired when a television program is watched, and image data received at the HDMI receiving section 111 are acquired when there is an input from outside.

The image quality improving process section 109 performs image quality improving processes such as a sharpness improving process, a contrast improving process, and a color improving process on image data acquired by the switch section 108 according to an operation performed by a user. The image quality improving process section 109 restricts an image quality improving process performed on image data associated with a region where an artificial image is combined with a natural image such that the region will not be adversely affected by the process. As a result, any variation of luminance or color attributable to the image quality improving process can be prevented in the region having the artificial image. Details of the image quality improving process portion 109 will be described later.

The panel driving circuit 112 drives the display panel 113 based on image data output from the image quality improving process section 109 or the video signal processing circuit 106. The display panel 113 is constituted by, for example, an LCD (liquid crystal display) or PDP (plasma display panel).

The audio decoder 114 performs a decoding process on an audio stream extracted by the demultiplexer 103 to obtain baseband (uncompressed) audio data. The switch section 115 selectively acquires audio data output by the audio decoder 114 or audio data received at the HDMI receiving section 111 according to an operation performed by a user. Audio data output by the audio decoder 114 are acquired when a television program is watched, and audio data received at the HDMI receiving section 111 are acquired when there is an input from outside.

The audio signal processing circuit 116 performs required processes such as a sound quality adjusting process and DA conversion on audio data acquired by the switch section 115. The sound quality adjusting process is performed, for example, according to an operation of a user. The audio amplifier circuit 117 amplifies an audio signal output by the audio signal processing circuit 116 and supplies the signal to the speaker 118.

The CPU 121 controls operations of various parts of the television receiver 100. The flash ROM 122 is provided for storing control programs and saving data. The DRAM 123 serves as a work area for the CPU 121. The CPU 121 deploys programs and data read from the flash ROM 122 on the DRAM 123 and activates the programs to control various parts of the television receiver 100.

The remote control receiving section 125 receives remote control signals (remote control codes) transmitted from the remote control transmitter 126 and supplies the signals to the CPU 121. Based on the remote control codes, the CPU 121 controls various parts of the television receiver 100. The CPU 121, the flash ROM 122, and the DRAM 123 are connected to the internal bus 120.

Operations of the television receiver 100 shown in FIG. 1 will now be briefly described. A television broadcast signal input to the antenna terminal 101 is supplied to the digital tuner 102. At the digital tuner 102, the television broadcast signal is processed to obtain a predetermined transport stream (TS) associated with a channel selected by a user. The transport stream is supplied to the demultiplexer 103.

The demultiplexer 103 extracts required streams such as a video stream, an audio stream, and a data stream from the transport stream. A video stream extracted by the demultiplexer 103 is supplied to the video decoder 104. The video decoder 104 performs a decoding process on the video stream to obtain baseband (uncompressed) image data. The image data are supplied to the combining process section 107.

A data stream extracted by the demultiplexer 103 is supplied to the BML browser 105. The BML browser 105 acquires BML data from the data stream and analyzes the structure of the data to generate image data for a data broadcast. The image data are image data for displaying an artificial image such as graphics or characters, and the data are supplied to the combining process section 107. At the combining process section 107, the image data obtained by the video decoder 104 is combined with the image data for a data broadcast generated by the BML browser 105 according to an operation performed by the user. Image data output by the combining process section 107 are supplied to the switch section 108.

The HDMI receiving section 111 performs communication according to the HDMI standard to receive baseband (uncompressed) image and audio data from the HDMI source apparatus. The image data received by the HDMI receiving section 111 are supplied to the switch section 108. The switch section 108 selectively acquires the image data output by the combining process section 107 or the image data received at the HDMI receiving section 111 according to an operation performed by a user. The image data output by the combining process section 107 are acquired when a television program is watched, and the image data received at the HDMI receiving section 111 are acquired when there is an input from outside. Image data output by the switch section 108 are supplied to the image quality improving process section 109.

The image quality improving process section 109 performs image quality improving processes such as a sharpness improving process, a contrast improving process, and a color improving process on the image data acquired by the switch section 108 according to an operation performed by a user. The image quality improving process section 109 restricts an image quality improving process performed on image data associated with a region where an artificial image is combined with a natural image such that the region will not be adversely affected by the process. Image data output by the image quality improving process section 109 or the video signal processing circuit 106 are supplied to the panel driving circuit 112. Therefore, an image associated with the channel selected by the user is displayed on the display panel 113 when a television program is watched, and an image received from the HDMI source apparatus is displayed when there is an input from outside.

An audio stream extracted by the demultiplexer 103 us supplied to the audio decoder 114. The audio decoder 114 performs a decoding process on the audio stream to obtain baseband (uncompressed) audio data. The audio data is supplied to the switch section 115.

Audio data received at the HDMI receiving section 111 are also supplied to the switch section 115. The switch section 115 selectively acquires the audio data output by the audio decoder 114 or the audio data received at the HDMI receiving section 111 according to an operation of the user. The audio data output by the audio decoder 114 is acquired when a television program is watched, and the audio data received at the HDMI receiving section 111 are acquired when there is an input from outside. The audio data output by the switch section 115 are supplied to the audio signal processing circuit 116.

At the audio signal processing circuit 116, required processes such as a sound quality adjusting process and DA conversion are performed on the audio data acquired by the switch section 115. An audio signal output from the audio signal processing circuit 116 is amplified by the audio amplifier circuit 117 and supplied to the speaker 118. Therefore, the speaker outputs sounds associated with the channel selected by the user when a television program is watched and outputs sounds received from the HDMI source apparatus when there is an input from outside.

### [Details of Image Quality Improving Process Section]

Details of the image quality improving process section 109 will now be described. FIG. 2 shows an exemplary configuration of the image quality improving process section 109. The image quality improving process section 109 includes a combining region detecting portion 131, a mask signal generating portion 132, a contrast improving process portion 133, a switch portion 134, a sharpness improving process portion 135, another switch portion 136, and an adding portion 137. The image quality improving process section 109 also includes a color improving process portion 138, another switch portion 139, another sharpness improving process portion 140, another switch portion 141, and another adding portion 142.

Luminance data Yin and chrominance data Cin are supplied to the image quality improving process section 109 as input image data (input video signals). The chrominance data Cin include red chrominance data and blue chrominance data. For simplicity of description, those items of data are collectively referred to as “chrominance data”. For example, the combining region detecting portion 131 detects a region of an artificial image combined with a natural image based on the luminance data Yin and transmits information of the region to the CPU 121.

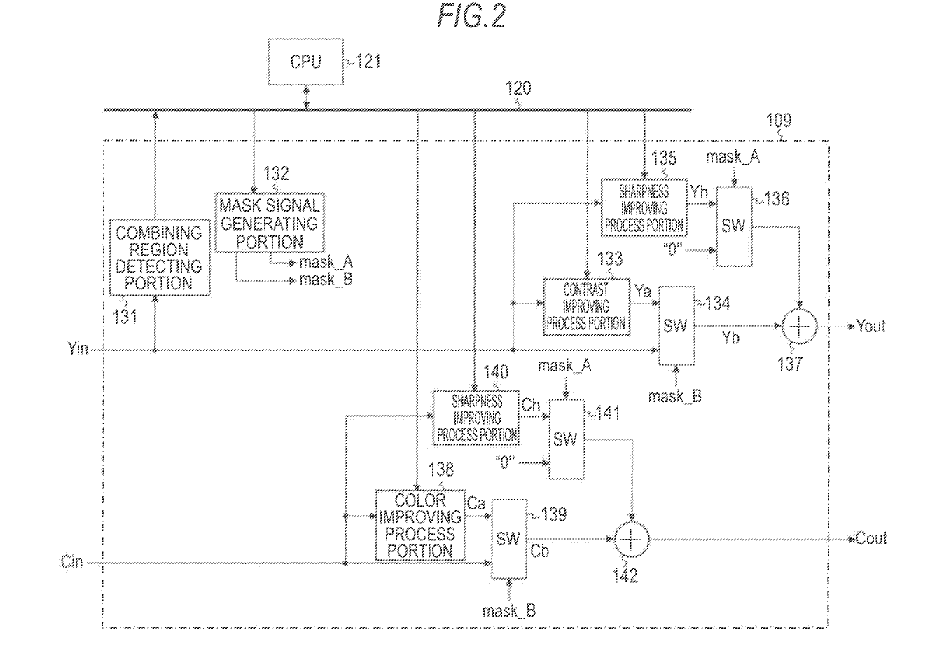

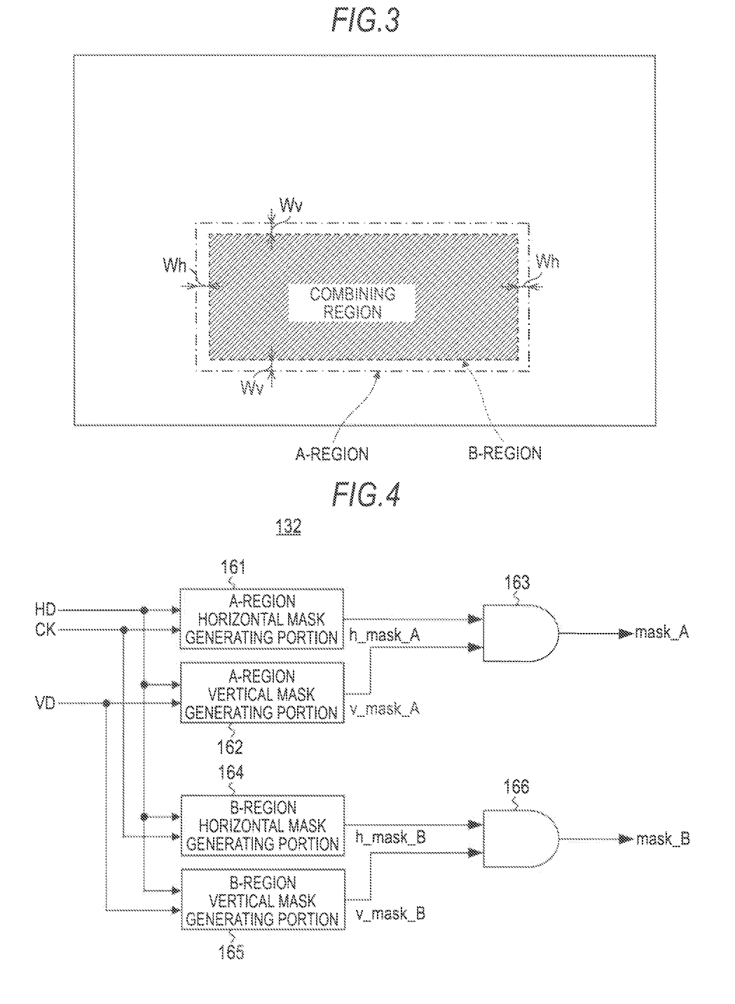

The mask signal generating portion 132 generates a mask signal mask_A (first mask signal) and a mask signal mask_B (second mask signal) under control exercised by the CPU 121. As shown in FIG. 3, a mask signal mask_A represents a region (A-region) overlapping and encompassing a region where an artificial image is combined. As shown in FIG. 3, a mask signal mask_B represents a region (B-region) which is identical to the region where an artificial image is combined. FIG. 3 shows an example in which there is one region where an artificial image is combined. When artificial images are combined in a plurality of regions, the mask signal generating portion 132 generates mask signals mask_A and mask_B in association with all image combining regions.

The mask signal generating portion 132 generates mask signals mask_A and mask_B based on information on a region where an artificial image is combined. As described above, the switch section 108 acquires image data output by the combining process section 107 when a television program is watched. The CPU 121 has information on a region where an artificial image (an image for a data broadcast) is combined by the combining process section 107. Therefore, when a television program is watched, such information held by the CPU 121 is used as artificial image combining region information.

As described above, when there is an input from outside, the switch section 108 acquires image data received at the HDMI receiving section 111. The CPU 121 has no information on an artificial image combining region according to the received image data. Therefore, when there is an input from outside, information on the region having an artificial image detected by the combining region detecting portion 131 is used as artificial image combining region information.

FIG. 4 shows an exemplary configuration of the mask signal generating portion 132. The mask signal generating portion 132 includes an A-region horizontal mask generating part 161, an A-region vertical mask generating part 162, and an AND circuit 163. The mask signal generating portion 132 also includes a B-region horizontal mask generating part 164, a B-region vertical mask generating part 165, and another AND circuit 166.

A pixel clock CK is input to the A-region horizontal mask generating part 161 and the B-region horizontal mask generating part 164. A horizontal synchronization signal HD is input to the A-region horizontal mask generating part 161, the A-region vertical mask generating part 162, the B-region horizontal mask generating part 164, and the B-region vertical mask generating part 165. A vertical synchronization signal VD is input to the A-region vertical mask generating part 162 and the B-region vertical mask generating part 165.

The A-region horizontal mask generating part 161 and the B-region horizontal mask part 164 are constituted by counters which are reset by the horizontal synchronization signal HD and incremented by the pixel clock CK. The A-region horizontal mask generating part 161 generates an A-region horizontal control signal h_mask_A, and the B-region horizontal mask part 164 generates a B-region horizontal control signal h_mask_B.

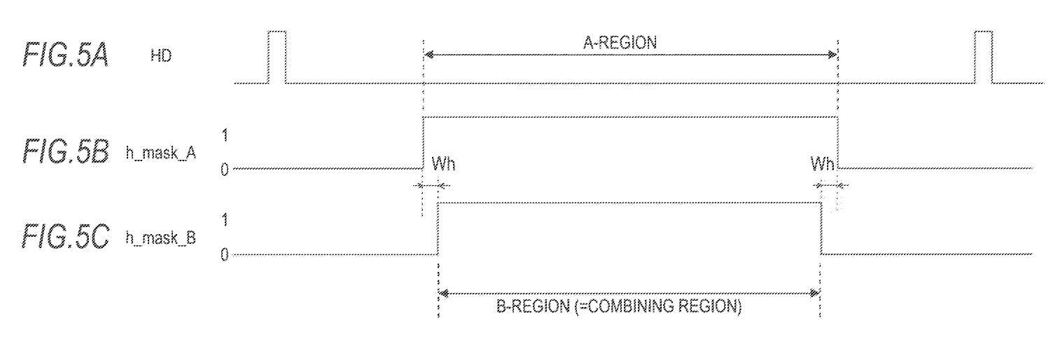

FIGS. 5A to 5C show examples of changes that occur in the A-region horizontal control signal h_mask_A and the B-region horizontal control signal h_mask_B relative to the horizontal synchronization signal HD. The horizontal synchronization signal HD is indicated in FIG. 5A. The A-region horizontal control signal h_mask_A is indicated in FIG. 5B. The B-region horizontal control signal h_mask_B is indicated in FIG. 5C.

The A-region horizontal control signal h_mask_A has a value “1” in an A-region (horizontal direction) and has a value “0” in other regions. Similarly, the B-region horizontal control signal h_mask_B has the value “1” in a B-region (horizontal direction) and has the value “0” in other regions. In this case, the A-region horizontal control signal h_mask_A stays at “1” longer than the B-region horizontal control signal h_mask_B by horizontal margins Wh.

The A-region vertical mask generating part 162 and the B-region vertical mask part 165 are constituted by counters which are reset by the vertical synchronization signal VD and incremented by the horizontal synchronization signal HD. The A-region vertical mask generating part 162 generates an A-region vertical control signal v_mask_A, and the B-region vertical mask part 165 generates a B-region vertical control signal v_mask_B.

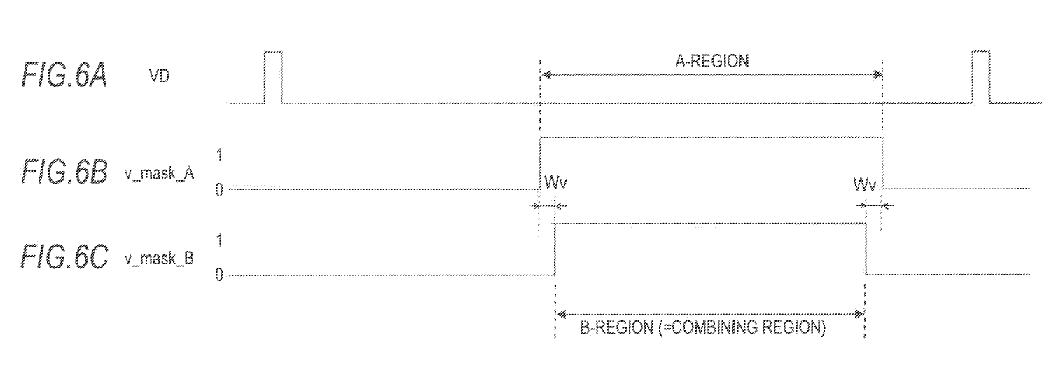

FIGS. 6A to 6C show examples of changes that occur in the A-region vertical control signal v_mask_A and the B-region vertical control signal v_mask_B relative to the vertical synchronization signal VD. The vertical synchronization signal VD is indicated in FIG. 6A. The A-region vertical control signal v_mask_A is indicated in FIG. 6C. The B-region vertical control signal v_mask_B is indicated in FIG. 6C.

The A-region vertical control signal v_mask_A has the value “1” in the A-region (vertical direction) and has the value “0” in other regions. Similarly, the B-region vertical control signal v_mask_B has the value “1” in the B region (vertical direction) and has the value “0” in other regions. In this case, the A-region vertical control signal v_mask_A stays at “1” longer than the B-region vertical control signal v_mask_B by vertical margins Wv.

The A-region horizontal control signal h_mask_A generated by the A-region horizontal mask generating part 161 and the A-region vertical control signal v_mask_A generated by the A-region vertical mask generating part 162 are input to the AND circuit 163. The A-region horizontal control signal h_mask_A and the A-region vertical control signal v_mask_A are ANDed by the AND circuit 163 to output a mask signal mask_A (first mask signal). The mask signal mask_A has the value “1” in the A-region and has the value “0” in other regions.

The B-region horizontal control signal h_mask_B generated by the B-region horizontal mask generating part 164 and the B-region vertical control signal v_mask_B generated by the B-region vertical mask generating part 165 are input to the AND circuit 166. The B-region horizontal control signal h_mask_B and the B-region vertical control signal v_mask_B are ANDed by the AND circuit 166 to output a mask signal mask_B (second mask signal). The mask signal mask_B has the value “1” in the B-region and has the value “0” in other regions.

In the present embodiment, the mask signal mask_B is used as a mask signal for a contrast improving process and a color improving process as will be described later. Therefore, a B-region is preferably set as a region that is identical to an artificial image combining region. In the present embodiment, the mask signal mask_A is used as a mask signal for a sharpness improving process. Therefore, each of the horizontal margins Wh and the vertical margins Wv of an A-region extending beyond an artificial image combining region is preferably set at about two pixels. When the size of those margins is too large, an area subjected to image processing becomes too noticeable. When the margins are too small, edges are excessively enhanced, which results in degradation of image quality.

Referring to FIG. 2 again, the contrast improving process portion 133 performs a luminance improving process on input luminance data Yin according to the histogram equalization which is well-known in the related art. Histogram equalization is a method in which a level conversion function is adaptively changed according to the frequency distribution of pixel values of an input image. The method allows gray levels to be corrected by decreasing gray levels in regions where pixel values are distributed at low frequencies.

The switch portion 134 selectively acquires input luminance data Yin or luminance data Ya output by the contrast improving process portion 133 based on a mask signal mask_B generated by the mask signal generating portion 132. Specifically, the switch portion 134 selects the input luminance data Yin for the B-region (the region identical to the artificial image combining region) for which the mask signal mask_B has the value “1” and selects the output luminance data Ya for other regions for which the mask signal mask_B has the value “0”. At the image quality improving process section 109, the contrast improving process is restricted for the B-region through the selective operation of the switch portion 134 as thus described. That is, the contrast improving process is not performed for the B-region in the present embodiment.

The sharpness improving process portion 135 extracts high frequency components Yh from the input luminance data Yin. The high frequency components Yh include both of high frequency components in the horizontal direction and high frequency components in the vertical direction. The sharpness improving process portion 135 extracts high frequency components in the horizontal direction using a horizontal high-pass filter formed by pixel delay elements as known in the related art. The sharpness improving process portion 135 extracts high frequency components in the vertical direction using a vertical high-pass filter formed by line delay elements as known in the related art.

The switch portion 141 selectively acquires the high frequency components Yh output from the sharpness improving process portion 135 or “0” based on the mask signal mask_A generated by the mask signal generating portion 132. That is, the switch portion 141 selects “0” in the above-described A-region (the region overlapping and encompassing the artificial image combining region) where the mask signal mask_A has the value “1” and selects the output high frequency components Yh in other regions where the mask signal mask_A has the value “0”.

The adding portion 137 adds data output by the switch portion 136 to luminance data Yb output by the switch portion 134 to obtain output luminance data Yout. At the image quality improving process section 109, the sharpness improving process on the input luminance data Yin is restricted in the A-region through the selective operation of the switch portion 136 as described above. That is, the sharpness improving process is not performed on the input luminance data Yin in the A-region in the present embodiment.

The color improving process portion 138 performs a color improving process on the input chrominance data Cin, for example, by increasing the color gain beyond 1 to display a vivid image. The switch portion 139 selectively acquires the input chrominance data Cin or chrominance data Ca output by the color improving process portion 138 based on the mask signal mask_B generated by the mask signal generating portion 132. Specifically, the switch portion 139 selects the input chrominance data Cin in a period associated with the above-described B-region (the region identical to the artificial image combining region) where the mask_signal_maskB has the value “1” and selects the output chrominance data Ca where the mask signal mask_B has the value “0”. At the image quality improving process section 109, the color improving process is restricted in the B-region through the selective operation of the switch portion 139 as thus described. That is, the color improving process is not performed in the B-region in the present embodiment.

The sharpness improving process portion 140 extracts high frequency components Ch from the input chrominance data Cin. The high frequency components Ch include both of high frequency components in the horizontal direction and high frequency components in the vertical direction. The sharpness improving process portion 140 extracts high frequency components in the horizontal direction using a horizontal high-pass filter formed by pixel delay elements as known in the related art. The sharpness improving process portion 140 extracts high frequency components in the vertical direction using a vertical high-pass filter formed by line delay elements as known in the related art.

The switch portion 136 selectively acquires the high frequency components Ch output from the sharpness improving process portion 140 or “0” based on the mask signal mask_A generated by the mask signal generating portion 132. That is, the switch portion 136 selects “0” in the above-described A-region (the region overlapping and encompassing the artificial image combining region) where the mask signal mask_A has the value “1” and selects the high frequency components Ch in other regions where the mask signal mask_A has the value “0”.

The adding portion 142 adds data output by the switch portion 141 to chrominance data Cb output by the switch portion 139 to obtain output chrominance data Cout. At the image quality improving process section 109, the sharpness improving process on the input chrominance data Cin is restricted in the A-region through the selective operation of the switch portion 141 as described above. That is, the sharpness improving process is not performed on the input chrominance data Cin in the A-region in the present embodiment.

Operations of the image quality improving process section 109 shown in FIG. 2 will now be described. Luminance data Yin constituting input image data are supplied to the combining region detecting portion 131. The combining region detecting portion 131 detects a region where an artificial image is combined with a natural image based on the luminance data Yin. Information on the combining region detected by the combining region detecting portion 131 is transmitted to the CPU 121.

The mask signal generating portion 132 generates a mask signal mask_A (first mask signal) and a mask signal mask_B (second mask signal) under control exercised by the CPU 121. A mask signal mask_A represents a region (A-region) overlapping and encompassing a region where an artificial image is combined. A mask signal mask_B represents a region (B-region) which is identical to the artificial image combining region (see FIG. 3).

Luminance data Yin constituting input image data are supplied to the contrast improving process portion 133. The contrast improving process portion 133 performs a luminance improving process such as histogram equalization on the input luminance data Yin.

Luminance data Ya output by the luminance improving process portion 133 are supplied to the switch portion 134. The input luminance data Yin are also supplied to the switch portion 134. Further, the mask signal mask_B generated by the mask signal generating portion 132 is supplied to the switch portion 134 as a switch control signal.

The switch portion 134 selectively acquires the input luminance data Yin or the luminance data Ya output by the contrast improving process portion 133 based on the mask signal mask_B. Specifically, the switch portion 134 acquires the input luminance data Yin in the above-described B-region (the region identical to the artificial image combining region) where the mask signal mask_B has the value “1” and acquires the luminance data Ya in other regions where the mask signal mask_B has the value “0”.

The luminance data Yin constituting the input image data are also supplied to the sharpness improving process portion 135. The sharpness improving process portion 135 extracts high frequency components Yh from the input luminance data Yin. The high frequency components Yh include both of high frequency components in the horizontal direction and high frequency components in the vertical direction. The high frequency components Yh output from the sharpness improving process portion 135 are supplied to the switch portion 136. Data “0” is also supplied to the switch portion 136. Further, the mask signal mask_A generated by the mask signal generating portion 132 is supplied to the switch portion 136 as a switch control signal.

The switch portion 136 selectively acquires the high frequency components Yh output from the sharpness improving process portion 135 or “0” based on the mask signal mask_A. That is, the switch portion 136 acquires in the above-described A-region (the region overlapping and encompassing the artificial image combining region) where the mask signal mask_A has the value “1” and acquires the output high frequency components Yh in other regions where the mask signal mask_A has the value “0”.

Data output by the switch 136 are supplied to the adding portion 137. Luminance data Yb output by the switch portion 134 are also supplied to the adding portion 137. The adding portion 137 adds the data output by the switch portion 136 to the luminance data Yb output by the switch portion 134 to obtain output luminance data Yout.

As described above, the switch portion 134 is controlled by the mask signal mask_B such that it acquires the input luminance data Yin in a period associated with the B-region and acquires the luminance data Ya in other periods. Therefore, the output luminance data Yout reflect a limited or no contrast improving effect in the B-region (the region identical to the artificial image combining region). In other words, the effect of the contrast improving process is reflected in the luminance data Yout only in the regions other than the B-region.

The switch portion 134 is controlled by the mask signal mask_A such that it acquires “0” in the A-region and acquires the output high frequency components Yh in other regions. Therefore, the adding portion 137 does not add the high frequency components Yh to the luminance data Yb output from the switch portion 134 in the A-region. Therefore, the output luminance data Yout reflect a limited or no sharpness improving effect in the A-region (the region overlapping and encompassing the artificial image combining region). In other words, the effect of the sharpness improving process is reflected in the output luminance data Yout only in the regions other than the region A.

Chrominance data Cin constituting the input image data are supplied to the color improving process portion 138. The color improving process portion 138 performs a color improving process on the input chrominance data Cin, for example, by increasing the color gain beyond 1 to display a vivid image. Chrominance data Ca output by the color improving process portion 138 are supplied to the switch portion 139. The input chrominance data Cin is also supplied to the switch portion 139. Further, the mask signal mask_B generated by the mask signal generating portion 132 is supplied to the switch portion 139 as a switch control signal.

The switch portion 139 selectively acquires the input chrominance data Cin or chrominance data Ca output by the color improving process portion 138 based on the mask signal mask_B. Specifically, the switch portion 139 acquires the input chrominance data Cin in the above-described B-region (the region identical to the artificial image combining region) where the mask signal mask_B has the value “1” and acquires the output chrominance data Ca in other regions where the mask signal mask_B has the value “0”.

The chrominance data Cin constituting the input image data are also supplied to the sharpness improving process portion 140. The sharpness improving process portion 140 extracts high frequency components Ch from the input chrominance data Cin. The high frequency components Ch include both of high frequency components in the horizontal direction and high frequency components in the vertical direction. The high frequency components Ch output from the sharpness improving process portion 140 are supplied to the switch portion 141. Data “0” is also supplied to the switch portion 141. Further, the mask signal mask_A generated by the mask signal generating portion 132 is supplied to the switch portion 141 as a switch control signal.

The switch portion 141 selectively acquires the high frequency components Ch output from the sharpness improving process portion 140 or “0” based on the mask signal mask_A. That is, the switch portion 141 acquires in the above-described A-region (the region overlapping and encompassing the artificial image combining region) where the mask signal mask_A has the value “1” and acquires the output high frequency components Ch in other regions where the mask signal mask_A has the value “0”.

Data output by the switch portion 141 is supplied to the adding portion 142. Chrominance data Cb output by the switch portion 139 are also supplied to the adding portion 142. The adding portion 142 adds the data output by the switch portion 141 to the chrominance data Cb output by the switch portion 139 to obtain output chrominance data Cout.

As described above, the switch portion 138 is controlled by the mask signal mask_B such that it acquires the input lchrominance data Cin in a period associated with the B-region and acquires the chrominance data Ca in other periods. Therefore, the output chrominance data Cout reflect a limited or no color improving effect in the B-region (the region identical to the artificial image combining region). In other words, the effect of the color improving process is reflected in the chrominance data Cout only in the regions other than the B-region.

The switch portion 141 is controlled by the mask signal mask_A such that it acquires “0” in a period associated with the A-region and acquires the output high frequency components Ch in other periods. Therefore, the adding portion 142 does not add the output high frequency components Ch to the chrominance data Cb output from the switch portion 139 in the period associated with the A-region. Thus, the output chrominance data Cout reflect a limited or no sharpness improving effect in the A-region (the region overlapping and encompassing the artificial image combining region). In other words, the effect of the sharpness improving process is reflected in the output chrominance data Cout only in the regions other than the region A.

The contrast improving process and the color improving process at the image quality improving process section 109 shown in FIG. 2 are restricted in the B-region which is identical to the artificial image combining region. Therefore, the contrast improving process and the color improving process result in no change in the luminance and color of the artificial image. The approach also eliminates the problem of a visually noticeable boundary which can appear between the processed region and the region of the natural image.

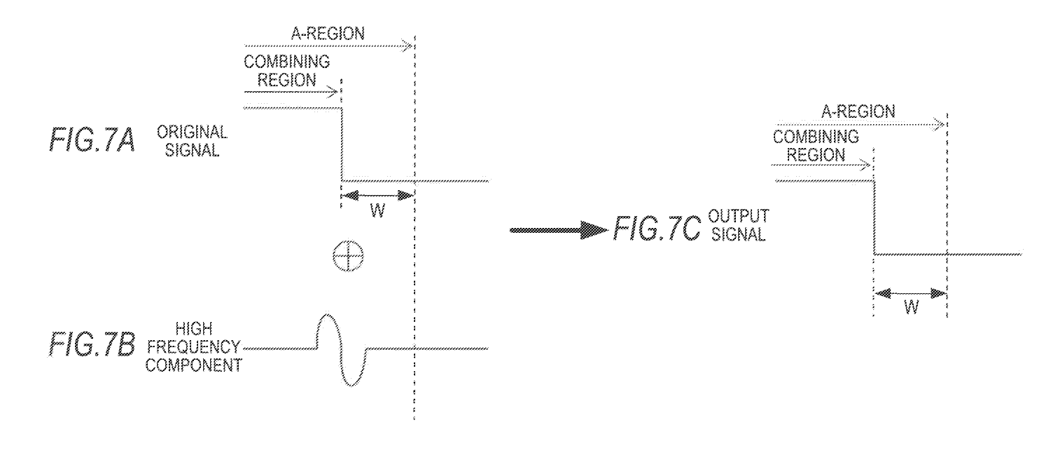

The sharpness improving process at the image quality improving process section 109 shown in FIG. 2 is restricted in the A-region overlapping and encompassing the artificial image combining region. The approach eliminates the problem of a visually noticeable trace of pre-shooting and over-shooting which can remain in the region of the natural image as a result of improved sharpness. The sharpness improving process results in no change in the luminance of the artificial image. For example, FIGS. 7A to 7C show an example of an original signal which is indicated in FIG. 7A and a high frequency component extracted from the original signal which is indicated in FIG. 7B. In an A-region which overlaps and encompasses an artificial image combining region, the sharpness improving process is not performed, and the high frequency component is not added to the original signal. Thus, a signal as indicated in FIG. 7C is output. Therefore, no visually noticeable trace of pre-shooting and over-shooting attributable to sharpness improvement appears in the region of the natural image.

As thus described, the image improving process section 109 shown in FIG. 2 leaves no visually noticeable boundary between a region subjected to a contrast improving process and a color improving process and a region of a natural image. Further, no visually noticeable trace of pre-shooting and over-shooting attributable to sharpness improvement appears in the region of the natural image. FIG. 8 shows an example of an image displayed using the image quality improving process section 109 shown in FIG. 2.

### 2. Modification

The sharpness improving process at the image quality improving process section 109 shown in FIG. 2 is restricted in an A-region overlapping and encompassing an artificial image combining region. That is, the image quality improving process section 109 performs no sharpness improving process in the A-region.

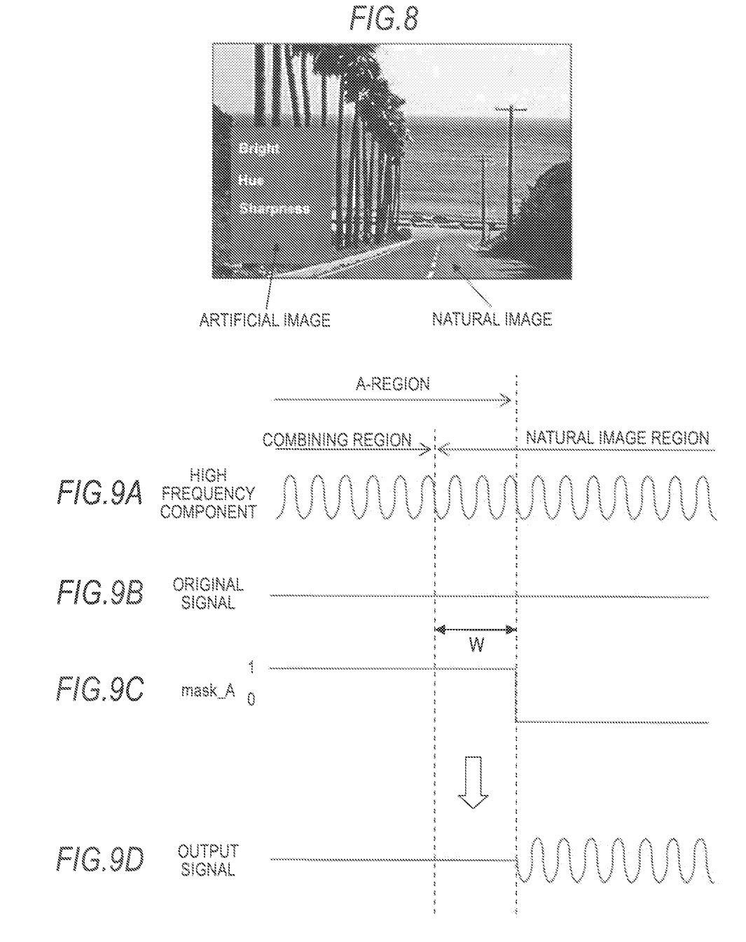

FIGS. 9A to 9D show examples of signals associated with the sharpness improving process performed by the image quality improving process section 109 shown in FIG. 2. An original signal is indicated in FIG. 9B, and high frequency components extracted from the original signal are indicated in FIG. 9A. A mask signal mask_A is indicated in FIG. 9C, and an output signal is indicated in FIG. 9D.

As apparent from FIGS. 9A to 9D, no sharpness improving process is performed at all in a marginal area W (corresponding to the margin Wh or Wv) of a natural image region located between a line representing an artificial image combining region and a line representing an A-region. The sharpness improving process is performed only outside the line representing the A-region. Therefore, when the marginal area W is large, the sharpness improving process may leave a visually noticeable boundary between the processed and unprocessed areas.

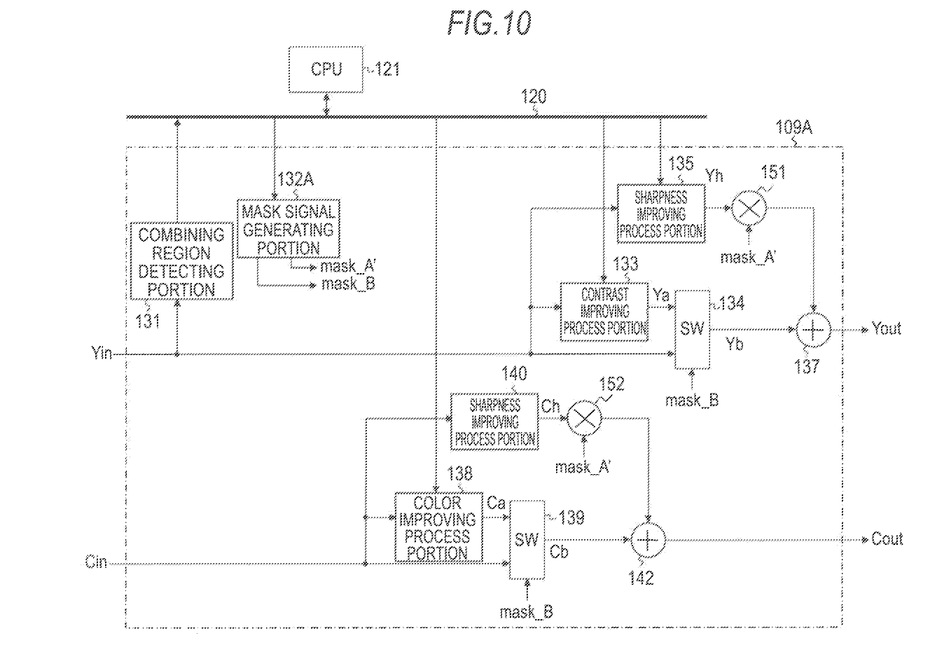

FIG. 10 shows an image quality improving process section 109A as a modification of the image quality improving process section 109 shown in FIG. 2. Elements corresponding between FIGS. 2 and 10 are indicated by like reference numerals, and detailed description will be omitted for such elements when appropriate.

A mask signal generating portion 132A generates mask signals mask_A′ and mask_B based on information on an artificial image combining region. The mask signal mask_B is similar to the mask signal mask_B generated by the mask signal generating portion 132 of the image quality improving process section 109 in FIG. 2. The mask signal mask_B has a value “1” in a B-region (a region identical to the artificial image combining region) and has a value “0” in other regions.

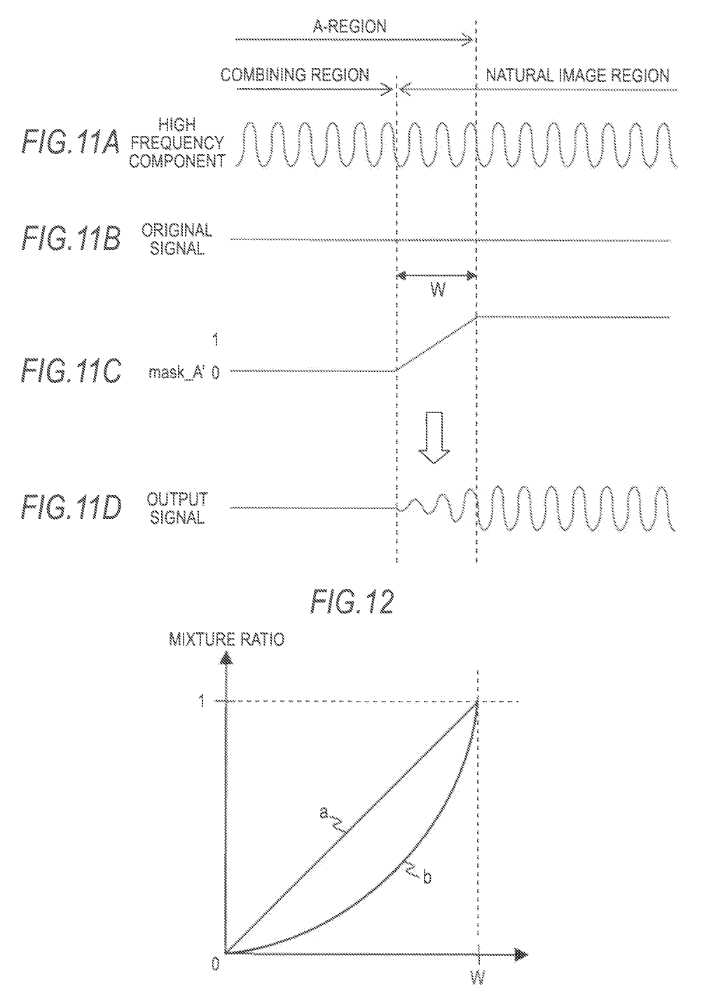

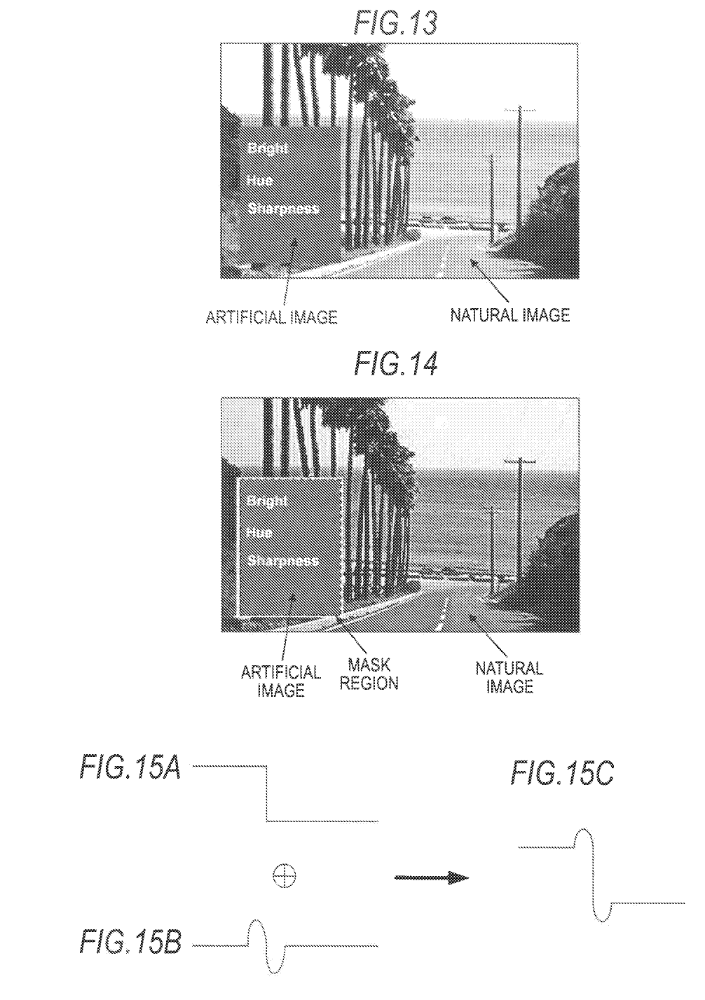

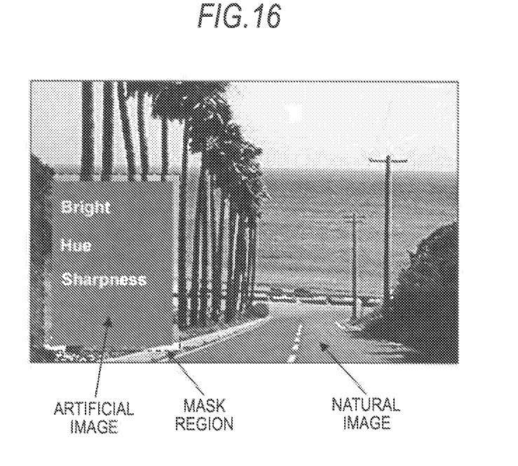

The mask signal mask_A′ is different from the mask signal mask_A generated by the mask signal generating portion 132 of the image quality improving process section 109 in FIG. 2. The mask signal mask_A′ has the value “0” in the artificial image combining region and has the value “1” in an A-region (a region overlapping and encompassing the artificial image combining region). Further, in a marginal area W between the line representing the artificial image combining region and the line representing the A-region, the value of the signal changes from “0” to “1”, as indicated in FIG. 11C. The change may proceed in a parabolic form as represented by a solid line b in FIG. 12 instead of a linear form as represented by a solid line a in FIG. 12.

A multiplying portion 151 multiplies high frequency components Yh output by a sharpness improving process portion 135 by the mask signal mask_A′ generated by the mask signal generating portion 132A. At this time, the multiplying portion 151 outputs “0” in the artificial image combining region. That is, none of the output high frequency components Yh of the sharpness improving process portion 135 is output from the multiplying portion 151 in the artificial image combining region.

In the region beyond the outline of the A-region, the high frequency components Yh from the sharpness improving process portion 135 are output as they are as the output of the multiplying portion 151. Further, in the area between the outline of the artificial image combining region and the outline of the A-region, the magnitude of the high frequency components output from the multiplier 151 gradually increases from 0 to Yh toward the outline of the A-region.

An adding portion 137 adds the data output by the multiplying portion 151 to luminance data Yb output by a switch portion 134 to obtain an output luminance data Yout. In the case of the image quality improving process section 109A, the above-described multiplying operation of the multiplying portion 151 allows the sharpness improving process to be performed on the input luminance data Yin even in the marginal area W (corresponding to the margin Wh or Wv) between the outline of the artificial image combining region and the outline of the A-region. The restriction placed on the sharpness improving process on the input luminance data Yin starts becoming weak beyond the outline of the artificial image combining region and becomes weaker toward the outline of the A-region.

A multiplying portion 152 multiplies high frequency components Ch output by a sharpness improving process portion 140 by the mask signal mask_A′ generated by the mask signal generating portion 132A. At this time, the multiplying portion 152 outputs “0” in the artificial image combining region. That is, none of the output high frequency components Ch of the sharpness improving process portion 140 is output from the multiplying portion 152 in the artificial image combining region.

In the region beyond the outline of the A-region, the output high frequency components Ch from the sharpness improving process portion 140 are output as they are as the output of the multiplying portion 152. Further, in the area between the outline of the artificial image combining region and the outline of the A-region, the magnitude of the high frequency components output from the multiplier 152 gradually increases from 0 to Ch toward the outline of the A-region.

An adding portion 142 adds the data output by the multiplying portion 152 to chrominance data Cb output by a switch portion 139 to obtain an output chrominance data Cout. In the case of the image quality improving process section 109A, the above-described multiplying operation of the multiplying portion 152 allows the sharpness improving process to be performed on the input chrominance data Cin even in the marginal area W (corresponding to the margin Wh or Wv) between the outline of the artificial image combining region and the outline of the A-region. The restriction placed on the sharpness improving process on the input chrominance data Cin starts becoming weak beyond the outline of the artificial image combining region and becomes weaker toward the outline of the A-region.

As described above, the image quality improving process section 109A performs the sharpness improving process not only in the are beyond the A-region but also in the marginal area inside the A-region. In addition, in the case of the image quality improving process section 109A, the restriction placed on the sharpness improving process on the input chrominance data Cin starts becoming weak beyond the outline of the artificial image combining region and becomes weaker toward the outline of the A-region. It is therefore possible to prevent the sharpness improving process from leaving a visually noticeable boundary between the processed and unprocessed areas even when the marginal area W is large.

FIGS. 11A to 11D show examples of signals associated with the sharpness improving process performed by the image quality improving process section 109A shown in FIG. 10. An original signal is indicated in FIG. 11C, and high frequency components extracted from the original signal are indicated in FIG. 11A. A mask signal mask_A′ as described above is indicated in FIG. 11C, and an output signal is indicated in FIG. 11D.

Although not described in detail, the configuration of the image quality improving process section 109A shown in FIG. 10 is otherwise the same as that of the image quality improving process section 109 shown in FIG. 2, and the section 109A can provide the same advantages as described above.

In the above description of the embodiment, the A-region has been described as having a fixed size. The size of the A-region may alternatively be varied depending on the quality of the natural image of interest. In this case, for example, the image quality improving process section 102 shown in FIG. 2 may be provided with a high frequency component extracting portion for extracting high frequency components of a natural image region based on input luminance data Yin, and level information of the components may be transmitted to the CPU 121.

The CPU 121 may control the size of the margin W (Wh or Wv) based on the level information of the high frequency components. For example, an area which has received the sharpness improving process is more visually noticeable against an area which has not received the process, the greater the amount of high frequency components. Therefore, in the case of a natural image including a great amount of high frequency components, the size of the margin W (Wh or Wv) is set small.

In the image quality improving process sections 109 and 109A shown in FIGS. 2 and 10, the respective mask signal generating portions 132 and 132A generate mask signals under control exercised by the CPU 121 to restrict the processes using the mask signals. Instead of restricting the processes using mask signals as thus described, for example, the CPU 121 may directly restrict each process depending on the region where the process is performed. As a result, the hardware configuration of the image quality improving process sections can be simplified.

In the above-described embodiment, the contrast improving process and the color improving process are restricted in a B-region (a region identical to an artificial image combining region). However, the invention is not limited to such a configuration. In general, a process to be restricted in a B-region is such a process that the pixels in the combining region will not affect the pixels outside the combining region.

In the above-described embodiment, the sharpness improving process is restricted in an A-region (a region overlapping and encompassing an artificial image combining region). However, the invention is not limited to such a configuration. In general, a process is to be restricted in an A-region when the pixels in the combining region will affect the pixels outside the artificial image combining region.

The embodiment of the invention may be applied to television receivers or the like in which image quality improving processes are restricted in a region having an artificial image such as a data broadcast image or characters by setting a mask area in such a region such that the processes will not affect the artificial image.

The present application contains subject matter related to that disclosed in Japanese Priority Patent Application JP 2009-195007 filed in the Japan Patent Office on Aug. 26, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A video signal processing device comprising:
a first video signal processing section performing a first process on an input video signal for displaying a composite image that is a combination of a natural image and an artificial image, the first process being performed on pixels in a region larger than an artificial image combining region and being a process on which pixels within the artificial image combining region have influence;
a second video signal processing section performing a second process on the input video signal, the second process being performed on pixels in a region larger than the artificial image combining region and being a process on which pixels within the artificial image combining region have no influence; and
a process restricting section restricting the first process performed by the first video signal processing section in a first region overlapping and encompassing the artificial image combining region and restricting the second process performed by the second video signal processing section in a second region which is identical to the artificial image combining region.

2. The video signal processing device according to claim 1, wherein the process restricting section starts relaxing the degree of the restriction on the first process by the first video signal processing section at the outline of the artificial image combining region and gradually relaxes the restriction toward the outline of the first region.

3. The video signal processing device according to claim 1, further comprising a mask signal generating section generating a first mask signal representing the first region and a second mask signal representing the second region, wherein the process restricting section restricts the first process performed by the first video signal processing section based on the first mask signal generated by the mask signal generating section and restricts the second process performed by the second video signal processing section based on the second mask signal generated by the mask signal generating section.

4. The video signal processing device according to claim 1, wherein the first process performed by the first video signal processing section is a sharpness improving process by which a high frequency component is extracted from the input video signal and the extracted high frequency component is added to the input video signal.

5. The video signal processing device according to claim 1, wherein the second process performed by the second video signal processing section is a contrast improving process performed on a luminance signal constituting the input video signal and a color improving process performed on a chrominance signal constituting the input video signal.

6. The video signal processing device according to claim 1, further comprising a combining region detecting section acquiring information on the artificial image combining region based on the input video signal, wherein the process restricting section restricts the first process performed by the first video signal processing section in the first region overlapping and encompassing the artificial image combining region and restricts the second process performed by the second video signal processing section in the second region which is identical to the artificial image combining region, based on the information on the artificial image combining region obtained by the combining region detecting section.

7. The video signal processing device according to claim 1, further comprising a video signal combining section combining a first video signal for displaying the natural image with a second video signal for displaying the artificial image to obtain the input video signal, wherein the process restricting section restricts the first process performed by the first video signal processing section to the first region overlapping and encompassing the artificial image combining region and restricting the second process performed by the second video signal processing section to the second region which is identical to the artificial image combining region, based on information on the artificial image combining region in the video signal combining section.

8. A video signal processing method comprising the steps of:
performing a first process on an input video signal for displaying a composite image that is a combination of a natural image and an artificial image, the first process being performed on pixels in a region larger than an artificial image combining region and being a process on which pixels within the artificial image combining region have influence;
performing a second process on the input video signal, the second process being performed on pixels in a region larger than the artificial image combining region and being a process on which pixels within the artificial image combining region have no influence; and
restricting the first process performed in a first region overlapping and encompassing the artificial image combining region and restricting the second process in a second region which is identical to the artificial image combining region.

9. A program executed on a computer for controlling a video signal processing device having
a first video signal processing section performing a first process on an input video signal for displaying a composite image that is a combination of a natural image and an artificial image, the first process being performed on pixels in a region larger than an artificial image combining region and being a process on which pixels within the artificial image combining region have influence, and
a second video signal processing section performing a second process on the input video signal, the second process being performed on pixels in a region larger than the artificial image combining region and being a process on which pixels within the artificial image combining region having no influence,
the program causing the computer to function as process restricting means for restricting the first process performed by the first video signal processing section in a first region overlapping and encompassing the artificial image combining region and restricting the second process performed by the second video signal processing section in a second region which is identical to the artificial image combining region.
